(19) United States
(12) Patent Application Publication
(10) Pub. No.: US 2015/0213472 A1
(43) Pub. Date: Jul. 30, 2015

(54) SYSTEM AND METHOD FOR ESTABLISHING AN ONLINE FINANCIAL INCENTIVE PROGRAM FOR FISCALLY RESPONSIBLE BEHAVIOR

(71) Applicant: FMR LLC, Boston, MA (US)

(72) Inventor: Ronald Raikula, Boston, MA (US)

(73) Assignee: FMR LLC, Boston, MA (US)

(21) Appl. No.: 14/167,568

(22) Filed: Jan. 29, 2014

(51) Int. Cl. G06Q 30/02

(52) U.S. Cl. CPC G06Q 30/0215

(57) ABSTRACT

Implementations are described for establishing an online financial incentive program that involve receiving first account information from a first user identifying financial account(s) authorized for monitoring and target financial account(s) authorized to receive funds from third party funding sources; receiving second account information from a second user identifying a source financial account to serve as one of the third party funding sources, at least one of the monitored accounts, and at least one of the target financial accounts; receiving reward criteria from the second user that defines a financial event associated with the selected monitored account and a corresponding contribution that is applied to the selected target account from the source financial account; tracking financial activity information from the selected monitored account; and directing funds from the source account to the selected target account when the tracked activity information corresponds to the financial event.

### FIELD OF INVENTION

The invention relates to system and methods for establishing an online financial incentive program in which participants, such as young adults, receive financial rewards from individual account holders, such as friends or family, by meeting predefined rewards criteria corresponding to desired fiscally responsible behavior with respect to a monitored financial account.

### BACKGROUND

In today's economy and rising costs of education and living expenses, it can be hard to inspire people, particularly young adults, to save money when they have increasing debt and limited income. Additionally, saving may be difficult for many people, especially those that do not have jobs offering benefits such as 401k plans. Accordingly, it is desirable, particularly for young adults, to establish fiscally responsible behavior and to ensure such persons become investors in their current financial health as well as their financial future. However, providing an incentive to stimulate and develop fiscally responsible behaviors can be difficult, particularly for those with limited and/or strained income situations.

### SUMMARY OF THE INVENTION

Embodiments of the invention are directed to methods, computer program products and computerized server apparatus for establishing an online financial incentive program for fiscally responsible behavior, that comprise structure, steps and instructions, respectively, for receiving first account information through a user interface from a first user, the first account information identifying one or more financial accounts authorized by the first user to be monitored and identifying one or more target financial accounts authorized by the first user to receive funds from third party funding sources; receiving second account information through the user interface from a second user (a friend or relative of the first user, for example), the second account information identifying a source financial account authorized by the second user to serve as one of the third party funding sources, at least one of the monitored accounts selected to be monitored, and at least one of the target financial accounts selected to receive funds from the source financial account if a reward criteria is met; receiving the reward criteria through the user interface from the second user, the reward criteria defining a desired financial event associated with the selected monitored account and a corresponding contribution that is applied to the selected target account from the source financial account; tracking financial activity information from the selected monitored account; and directing funds from the source financial account of the second user to the selected target account of the first user as defined by the corresponding contribution of the reward criteria when the tracked financial activity information corresponds to the desired financial event.

In any of the foregoing embodiments, the desired financial event can be a one-time financial event or a plurality of financial events occurring over a specified period of time. The selected monitored account can be a debt account and the desired financial event can be an on-time payment made to the debt account, a plurality of on-time payments made to the debt account over a period of time, an over-payment or a full payment made to the debt account, maintenance of a current balance in the debt account, or continued progression of outstanding balance toward a specified goal in the debt account. The desired financial event can be a transfer from the selected monitored account of the first user to a charitable giving account or a retirement savings account. The desired financial event can be a credit score falling below a specified threshold or being maintained within a specified range.

Embodiments of the invention can further comprise structure, steps and instructions, respectively, for receiving contact information of the second user through the user interface from the first user; and using the contact information of the second user to send an electronic invitation to initiate establishment of the second user as one of the third party funding sources of the online financial incentive program. Embodiments of the invention can further comprise structure, steps and instructions, respectively, for receiving contact information of the first user through the user interface from the second user; and using the contact information of the first user to send an electronic invitation to initiate establishment of the first user as a target participant of the online financial incentive program.

Embodiments of the invention can further comprise structure, steps and instructions, respectively, for directly transferring the funds from the source financial account of the second user to the selected target account of the first user. Embodiments of the invention can further comprise structure, steps and instructions, respectively, for communicating with an external server computer to transfer the funds from the source financial account of the second user to the selected target account of the first user. Embodiments of the invention can further comprise structure, steps and instructions, respectively, for directing the funds to a pending rewards account for a period of time prior to transfer to the selected target account; reducing at least a portion of the funds in the pending rewards account whenever the desired financial event does not occur during the period of time; and directing the reduced funds from the pending rewards account to the selected target account of the first user at the end of the period of time.

Other aspects of the invention will become apparent from the following detailed description, taken in conjunction with the accompanying drawings, illustrating the principles of the invention by way of example only.

### BRIEF DESCRIPTION OF THE DRAWINGS

The foregoing and other objects, features, and advantages of the present invention as well as the invention itself, will be more fully understood from the follow description of various embodiments, when read together with the accompanying drawings.

FIG. 1 is a system diagram illustrating an environment in which embodiments of the invention can be implemented.

FIG. 2 is a flow diagram illustrating a method for establishing user accounts for an online financial incentive program for fiscally responsible behavior, according to one embodiment.

FIG. 3 is a flow diagram illustrating a method for monitoring designated monitored accounts and providing match or reward funds to a user target account, according to one embodiment.

FIG. 4 is a diagram illustrating an exemplary computer system for an online financial incentive program.

### DETAILED DESCRIPTION

Systems, methods, computer program products and computerized server apparatus are described herein for establishing an online financial incentive program in which participants, such as young adults, receive financial rewards from individual account holders, such as friends or family, by meeting predefined rewards criteria corresponding to desired fiscally responsible behavior with respect to a monitored financial account. For example, embodiments can be implemented to inspire people with debt and or limited income to stay fiscally responsible and begin a retirement savings program. In a hard economy and even in a good economy, it can be hard to inspire people, particularly young adults, to save money when they have debt and limited income and/or may not have jobs that offer benefits such as 401k plans. The purpose is therefore to establish habits consistent with healthy finances and ensure such persons become investors in their current financial health as well as their financial future.

Particular embodiments can be geared to provide incentive to a person of limited means to develop fiscally responsible behavior by enhancing the earning and savings power of a credit card rewards program via rewards and/or matching funds from source accounts of interested third parties such as friends and family. There can be varying degrees of payment rewards, or funds match, by such outside parties, who can choose to provide incentive for indications of fiscal responsibility by making a match or reward amount contingent on a set of predetermined behaviors, such as timely payment of at least the minimum payment on another unrelated account. Further incentive or rather disincentive can be provided as well by a garnering of pending matching rewards for actions resulting in default, or other indications of non-fiscally responsible behavior.

For example, in one scenario, a young adult in college may not have the funds or have limited funds for covering expenses, loans, credit cards, etc. and/or may be distracted by the demands on their time from school programs, new environments, and the unfamiliar when dealing with the own finances apart from their parents direct assistance. Embodiments of the invention can be implemented that provide incentive to the young adult to be financially responsible by providing an avenue for savings built partly with other people's money, i.e., a matching process. Thus, such embodiments brings attention to the importance of financial health and fiscal responsibility, by providing more wealth to the young adult for modest behavioral changes, i.e., incentives to be financially prudent and establish behaviors consistent with fiscal fitness. In this example, the parent likewise is able to, perhaps from more of a distance, provide via such embodiments a financial education for the young adult and teach responsible financial behaviors without seeming overbearing. Embodiments of the invention can be implemented for other customers/users in similar situations, and even other multi-generational relationships, to initiate retirement savings and educate adults around benefits of matching plans like 401ks and provide a modest safeguard against actions leading to defaults and possibly reduce the likelihood of defaults by instilling fiscally responsible habits.

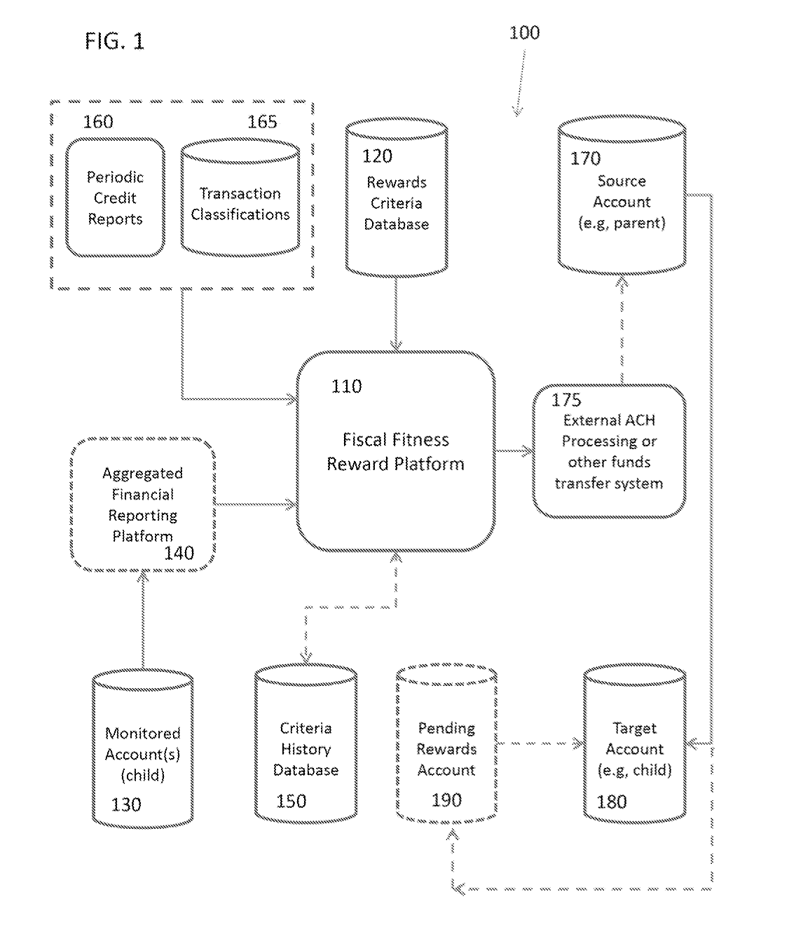

FIG. 1 is a system diagram illustrating an environment in which embodiments of the invention can be implemented. As shown, the system 100 includes a fiscal fitness reward platform 110 to which information is received from or output to various databases, systems, and other platforms in the system 100. The platform 110, which can be implemented as a server computer in a client-server environment (e.g., Internet) can provide a computer interface (e.g., web page interface) to allow an interested party, such as a parent, to sign up for the rewards program. The rewards program can allow the interested party to reward the other party, such as an adult child, that holds a credit card account set up through the system 100. The rewards can be set up by the owner or the interested party for certain behaviors or conditions, including behaviors such as on-time payments, greater than minimum payments, zero balances, or declining balances. Additionally, rewards can be based upon purchases or donations made to charities. The rewards can be given in the form of dollars or points that later are aggregated and equate to a dollar sum. The conditions to earn rewards can be set up and saved in the system. For example, such conditions can be saved in a separate or internal database, shown in FIG. 1 as the rewards criteria database 120. The conditions are based on activities of the card holder, which are monitored in the card owner's other accounts 130. The card owner can decide which accounts and which activities for each account may be monitored by the system 100.

The information obtained from monitoring the monitored accounts 130 can be fed directly to the fiscal fitness reward platform 110 or can be temporarily fed into an intermediate system such as an aggregated financial reporting platform 140. At the reporting platform 140, the rewards, points or otherwise can be aggregated and fed into the fiscal fitness reward platform 110 at designated times or in real time as activities are made by the card owner. For example, the accounts may be monitored and only the aggregation of the card owner's good and bad activities over a month, six month or a year is fed into the fiscal fitness reward platform 110. Alternatively, the accounts of the card owner can be monitored and the monitored information 130 is fed directly to the fiscal fitness reward platform 110 in real time to provide immediate incentive or disincentive to the card owner for good or bad activities, respectively.

For each dollar or point earned by the user of the card's points program, the interested party or parent can contribute to the matching account at some level, i.e., matching dollar for dollar or dollar for every ten dollars. The interested party can also determine the level of their contribution either based on criteria set by the card owner or criteria set by the interested party. History of criteria and changes to criteria for providing rewards can be tracked or maintain in a separate database such as the criteria history database 150, which can be located internally or externally to the system 100. This can allow the capturing of history related to the reward account for addressing reward conditions that apply over time or can allow the card owner or the interested party to track progress over time. Such history information can be captured to support trend goals or spot trends for the participants.

In addition to the monitored accounts 130 of the card owner, the system 100 can also account for monitoring of the card owners credit report or other transactions that can serve to show the card owner's financial health. To do so, the system 100 can access the card owner's credit rating through receipt of a periodic credit report 160. The card owner can provide access to the credit report and have his or her credit report sent to the fiscal fitness reward platform 110. Additionally, the card owner can allow the system to track classification information of specific transactions 165 to allow the system to further evaluation the card owner's financial health or responsible behavior, such as donating to a charitable giving account or round up services where purchase values are rounded to put the rounded up value into a retirement savings account. Such behavior, if added to criteria for financially responsible behavior to be tracked, can be tracked at the card owner's initiative.

In addition to setting the criteria for when a reward is given, the reward type or reward amount can also be set by the users of the system 100. This reward, whether an immediate dollar amount or a point value that later accrues to a dollar amount, is a contribution of funds from the interested party. This contribution can be a charge to a supplied account controlled by the interested party. This supplied account is shown as the source account 170 and the information is supplied or provided by the interested party when they sign up for the program provided by the system. The matching or reward amount can be some portion of a payment amount made to one of the monitored accounts. For example, when a payment of a monitored account 130 is received by the credit card billing platform, the information is provided to the system reward platform 110, and then an additional payment of some portion is made to the card owner's saving account 180 or alternatively made against the remaining balance of the monitored account 130 from the source account 170, i.e., the interested party's account. The payment, or transfer from the source account 170 to a target account 180 of the card owner, can be made via external ACH (Automated Clearing House) processing or another known funds transfer system 175. The reward payment, via rewards dollars or points accumulating into dollars, can be transferred directly to the target account 180 from the source account 170, or if the rewards or points are to be tallied periodically, for example weekly or monthly, then the rewards or points can be transferred intermediately to a pending rewards account 190 where the rewards would accumulate and an aggregated amount would periodically be determined and taken from the source account 170 transferred to the target account 180.

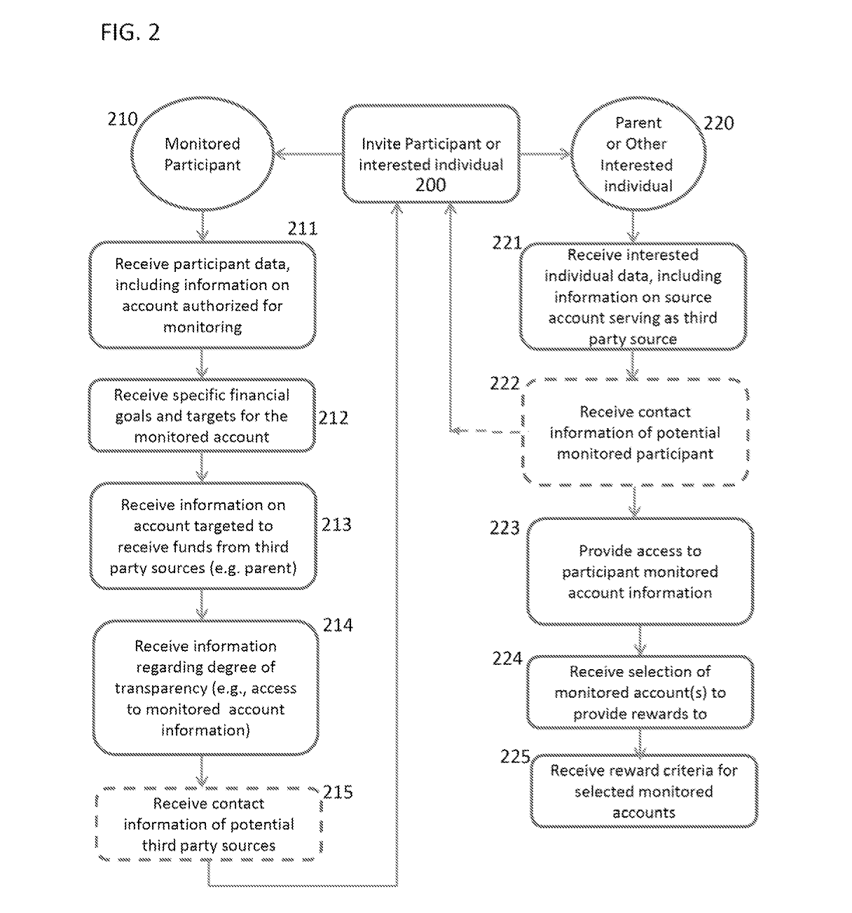

FIG. 2 is a flow diagram illustrating a method for establishing user accounts for an online financial incentive program for fiscally responsible behavior, according to one embodiment.

At 200, the fiscal fitness reward platform 110 can transmit an electronic invitation to an individual to participate in the program either as a monitored participant 210 or as a third party funding source (e.g., parent of other interested individual) 220. Such invitations can be made by electronic mail or other automated means of communication. The following description of the process is described from the perspective of a monitored participant 210 originating the process. However, the process can also be initiated by a parent or other interested individual serving as the third party funding source 220 of the rewards.

At 210, the card owner, or young adult in one example, decides to become a participant in the rewards program. To do so, the user logs onto the fiscal fitness reward platform 110 through a graphical user interface (e.g., a web page) and elects to become a monitored participant 210.

At 211, the fiscal fitness reward platform 110 receives, through the user interface, data from the monitored participant, including information relating to an account authorized by the for monitoring within the rewards program, i.e., the user specifies which accounts are to be monitored based on later established criteria to obtain incentives or rewards based on financially responsible behaviors.

At 212, the fiscal fitness reward platform 110 receives, through the user interface, user-specific financial goals that the monitored participant wants to achieve or financial targets to hit in various accounts 212. For example, the monitored participant may wish to save up $5000 for a car or pay down a $5000 balance on a credit card that accrued during college when funds were low. The monitored participant can then establish these savings or balance amounts as a healthy financial goal to aspired to and to track.

At 213, the fiscal fitness reward platform 110 receives, through the user interface, information relating to the account targeted to receive funds (i.e., rewards) from a third party source (e.g. source account 170 of a friend or family member).

At 214, the fiscal fitness reward platform 110 receives, through the user interface, information regarding a degree of transparency (e.g. a level of access) to the monitored account information. For example, the monitored participant can allow access to detailed information regarding all transaction associated with the monitored account, or some other subset thereof (e.g., mere notice of timely payments, minimum payment amounts, etc.).

At 215, the fiscal fitness reward platform 110 receives, through the user interface, contact information of potential interested individuals 220 having accounts that can serve as potential third party sources. Such contact information can be used to invite a parent or other interested individual 220 to participate in the program as a third party funding source at 200.

At 221, the fiscal fitness reward platform 110 receives, through the user interface, data from a parent or other interested individual 220, including information relating to a source account designated by the interested individual as the account to server as a third party funding source.

At 222, in the event the interested individual 220 initiates the process, the fiscal fitness reward platform 110 can receive, through the user interface, contact information of a potential candidate to invite as a monitored participant back at 200.

At 223, once the third party funding source and a monitored participant are established, the fiscal fitness reward platform 110 can provide the interested individual 220 with access, through the user interface, to information related to the monitored participant's accounts that are available for selection. Such access can be based on the level or degree of transparency set by the monitored participant at 214.

At 224, the fiscal fitness reward platform 110 receives, through the user interface, a selection from the interested individual 220 of which monitored accounts to provide rewards to. In other words, through the user interface, the parent or other interested individual 220 can specify which of the monitored accounts they would like to keep track of or simply which accounts they would like to ensure the monitored participant is staying on top of or being financially responsible. For example, a parent might care that their child is making on time and at least the minimum payments on a credit card that the parent is essentially responsible for or for a car payment that the parents have co-signed for. On the other hand, a grandparent or friend may only be concerned about the child or friend saving enough money to buy a car or save for school or retirement. Thus, the interested individual can choose which monitored accounts will have an impact on their contribution to the monitored participant.

At 225, the fiscal fitness reward platform 110 receives, through the user interface, reward criteria for the selected monitored accounts. For example, the parent or other interested individual 220 can define what criteria to look for when monitoring the monitored accounts. Alternatively, the monitored participant can define what criteria to be monitored and let the interested individual 220 select which of the criteria established by the monitored participant to monitor. For example, criteria can be based on financial health rules such as: on time payments vs. late payments, overpayments vs. minimum payments vs. partial payments, whether there is an outstanding balance, whether there is outstanding balance that is making progress towards specified goal(s); the monitored participant's credit score. Additionally, the criteria can be based on financial activity such as: whether an actual payment was received; whether a minimum payment is made, whether an overpayment of the minimum was paid, whether a balance was paid in full, or a donation was made to a charitable giving account, a payment was made to a retirement savings account.

Alternatively, the selected criteria can be based on negative behavior and funds rewarded for good behavior can be deducted based on fiscally irresponsible behavior such as: not making payments on time, or an accrual of bad behavior signified by a credit score declining below a defined threshold. Further criteria can be based on aggregated activity by the monitored participant. For example, the criteria can be such that no reward is provided unless “x” months of activity meet other specified criteria for rewards, or no reward unless all monitored accounts (of a certain type or types) meet specified criteria for reward.

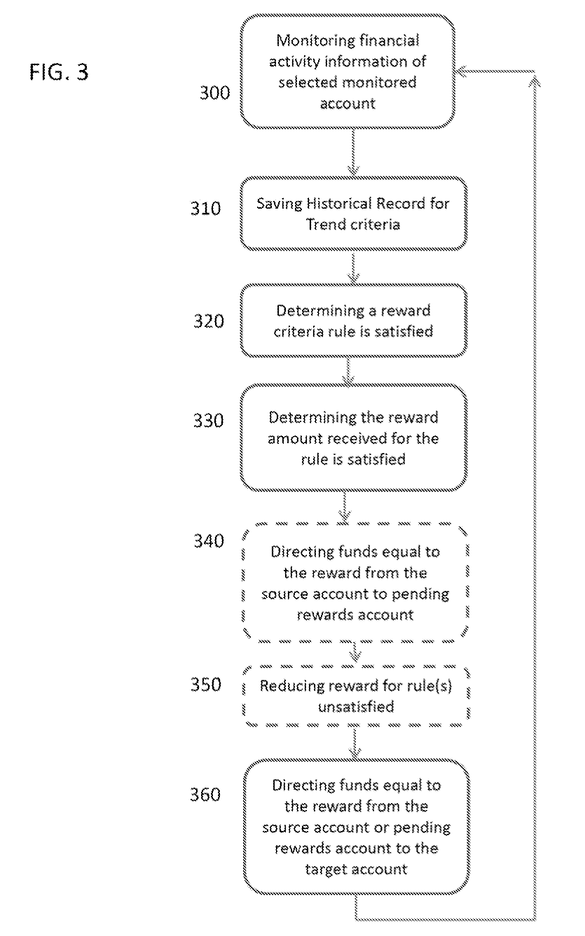

FIG. 3 is a flow diagram illustrating a method for monitoring designated monitored accounts and providing match or reward funds to a user target account, according to one embodiment.

At 300, the fiscal fitness reward platform 110 tracks the financial activity information (e.g., payments or current balances from a credit card billing platform or other debt platform such as student loans, car payments, or utility bills) for each of the selected monitored accounts.

At 310, the fiscal fitness reward platform 110 saves the tracked financial activity information as part of a historical record for determining trends or for rewards criteria that are applicable to financial events occurring over an extended period of time, e.g. weeks, months, etc.

At 320, the fiscal fitness reward platform 110 compares the financial activity to the rewards criteria (e.g., rules) selected by the interested individual for the selected monitored account and determines whether a reward criteria rule is satisfied.

At 320, the fiscal fitness reward platform 110 determines that a reward criteria rule is satisfied based on information monitored and/or information accumulated and retrieved from the historical record accumulated at 310.

At 330, if a criteria rule is satisfied, the fiscal fitness reward platform 110 determines the type or amount of reward to be received for each of the rules or criteria satisfied. The “reward” can be a positive reward or a negative reward (e.g., garnishment from rewards).

At 340, once the type and or amount of reward is determined at 330, the fiscal fitness reward platform 110 can direct the funds equal to the reward from the source account to a pending reward account, if a pending rewards account 190 has been established. Such a pending reward account can accumulate the rewards over a given period of time and only transfer the total rewards accumulated periodically. For example, the pending rewards account can be periodically (monthly, quarterly, semi-annually, annually) swept into a target account (such as an IRA or equivalent) as long as continuing thresholds are met such as a long standing credit score over 650 or only if no payments were missed over the given period. On the other hand, if the criteria establishes matching funds, the participant can determine via the criteria established whether these mating funds will automatically trigger a debit of the matching amount from the third party's account to the target account as part of an automatic sweep process instead of going through the pending rewards account. The pending rewards account can accumulate contributions, including matching points, such that a total amount can be transferred periodically, which can allow the interested party to know when funds will be transferred from their account and prepare for the loss of funds. Likewise, the pending rewards account allows the card owner to receive rewards at a periodic interval and therefore knows when to expect rewards. This provides a way of tracking incentives earned and allow the participants to more fully appreciate a larger effect of the accumulated rewards.

At 350, the pending rewards account 190 can also allow for the reduction of rewards due to criteria or due to unsatisfied criteria. For example, criteria met causing the reduction of rewards may be the card owner's credit score going under 650. An example of unsatisfied criteria, on the other hand, can include the monitored participant missing a car payment. The pending rewards account, which has the accumulation of rewards or points, can then have rewards or points deducted from the total rewards or points for criteria or unsatisfied criteria if such rules are set up by the participants.

At 360, whether the funds are received directly from the source account or whether the funds are received via the pending rewards account, the funds, equal to the reward earned or the total rewards accumulated, are directed or transferred to the target account. The target account is the account designated by the monitored participant for receiving funds from third parties interested in promoting financially responsible behaviors with the participant. This process can be repeated periodically or in real time as long as the participants are part of the program. Of course, the system can provide a method for ending the program for either the monitored participant or the interested party(s). Additionally, the system can provide a method of removing accounts from the monitored account list or for removing source accounts from the third party source list in the system.

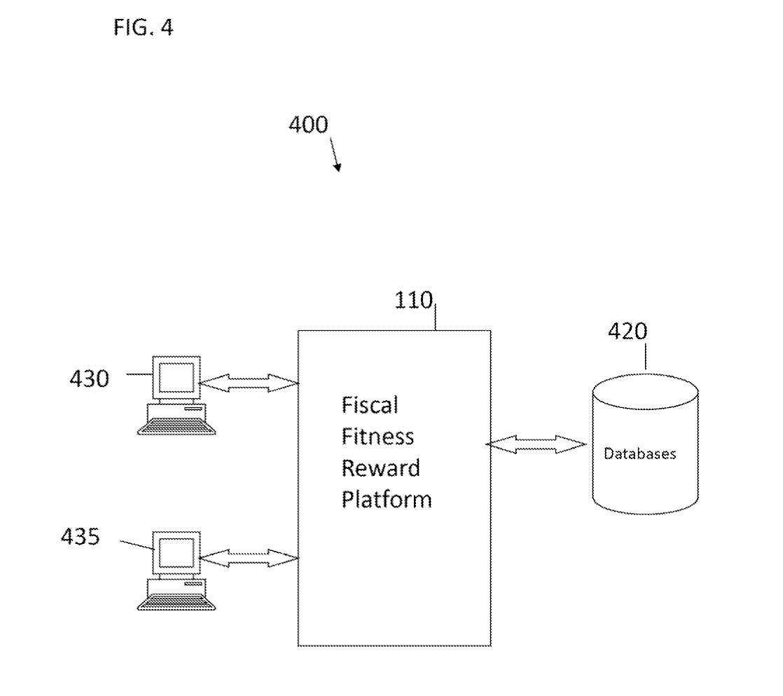

FIG. 4 is a diagram illustrating an exemplary computer system for an online financial incentive program. The components shown here, their connections and relationships, and their functions, are meant to be exemplary only, and are not meant to limit implementations of the personalized retirement tool described and/or claimed in this document.

The fiscal fitness reward platform 110, embodiments of which are described above in connection with FIGS. 1-3, is in communication with one or more computing devices 430, 435, and one or more databases 420. The platform 110 can be implemented as a server computer in a client-server environment (e.g., Internet) that provides a computer interface (e.g., web page interface) to allow the monitored participants (e.g. adult child) and interested party (e.g., friends and relatives) to sign up for and establish a rewards program for such participants. The computing devices 430, 435 are intended to represent various forms of digital computers, such as laptops, desktops, workstations, personal digital assistants, that can be operated by the participants and interested parties to interact with the platform through the computer interface. The databases can include a rewards criteria database, history database and a number of other databases that store information regarding source accounts, target accounts, monitored accounts, for example.

The fiscal fitness reward platform 110 can process instructions, including but not limited to, instructions stored in the fiscal fitness reward platform 110, one or more of the databases 420 or other external computing resources. Such processed instructions can result in the generation of various information displays for a graphical user interface (GUI) of an external input/output device coupled or integrated in computing devices 130, 135.

Further, the above-described techniques can be implemented in digital electronic circuitry, or in computer hardware, firmware, software, or in combinations of them. The implementation can be as a computer program product, i.e., a computer program tangibly embodied in a machine-readable storage device, for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps can be performed by one or more programmable processors executing a computer program to perform functions of the invention by operating on input data and generating output. Method steps can also be performed by, and apparatus can be implemented as, special purpose logic circuitry, e.g., an FPGA (field programmable gate array) or an ASIC (application specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Data transmission and instructions can also occur over a communications network.

Machine-readable storage devices suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the above described techniques can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The above described techniques can be implemented in a distributed computing system that includes a back-end component, e.g., as a data server, and/or a middleware component, e.g., an application server, and/or a front-end component, e.g., a client computer having a graphical user interface and/or a Web browser through which a user can interact with an example implementation, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet, and include both wired and wireless networks. Communication networks can also all or a portion of the PSTN, for example, a portion owned by a specific carrier.

The computing system can include clients and servers. A client and server are generally remote from each other and typically interact through a communication network. The relationship of client and server arises by virtue of computer programs running on the respective computers and having a client-server relationship to each other.

While this invention has been particularly shown and described with references to preferred embodiments thereof, it will be understood by those skilled in the art that various changes in form and details may be made therein without departing from the scope of the invention encompassed by the appended claims.

1. A computer-implemented method for establishing an online financial incentive program for fiscally responsible behavior, the method comprising:
receiving, by a sewer computer, first account information from a first user through a first user interface operating on a first client computing device, the first account information identifying one or more financial accounts of the first user authorized by the first user to be monitored by a second user, a level of access set by the first user to control access of the second user to financial activity information of the one or more financial accounts of the first user authorized by the first user to be monitored by the second user, and one or more target financial accounts of the first user authorized by the first user to receive funds from the second user;
receiving, by the server computer, second account information from the second user through a second user interface operating on a second client computing device, the second account information identifying a source financial account of the second user, at least one of the monitored accounts of the first user selected to be monitored, and at least one of the target financial accounts of the first user selected to receive funds from the source financial account of the second user if a reward criteria is met;
receiving, by the server computer, the reward criteria from the second user through the second user interface, the reward criteria being a desired set of financial events defined by the second user based on the financial activity information accessible to the second user from the selected monitored account of the first user and a corresponding contribution that is applied to the selected target account of the first user from the source financial account of the second user
tracking, by the server computer, the financial activity information accessible to the second user from the selected monitored account of the first user;
directing, by the server computer, funds from the source financial account of the second user to the selected target account of the first user as defined by the corresponding contribution of the reward criteria when the tracked financial activity information corresponds to the desired financial event.

2. The method of claim 1 further comprising:
receiving, by the server computer, contact information of the second user through the first user interface from the first user; and
using, by the server computer, the contact information of the second user to send an electronic invitation to initiate establishment of the second user as one of the third party funding sources of the online financial incentive program.

3. The method of claim 1 further comprising:
receiving, by the server computer, contact information of the first user through the second user interface from the second user; and
using, by the server computer, the contact information of the first user to send an electronic invitation to initiate establishment of the first user as a target participant of the online financial incentive program.

4. The method of claim 1 wherein the second user is a friend or relative of the first user.

5. The method of claim 1 further comprising:
directly transferring, by the server computer, the funds from the source financial account of the second user to the selected target account of the first user.

6. The method of claim 1 further comprising:
communicating, by the server computer, with an external server computer to transfer the funds from the source financial account of the second user to the selected target account of the first user.

7. The method of claim 1 wherein the desired financial event is a one-time financial event or a plurality of financial events occurring over a specified period of time.

8. The method of claim 1 wherein the selected monitored account is a debt account and the desired financial event is an on-time payment made to the debt account, a plurality of on-time payments made to the debt account over a period of time, an over-payment or a full payment made to the debt account, maintenance of a current balance in the debt account, or continued progression of outstanding balance toward a specified goal in the debt account.

9. The method of claim 1 wherein the desired financial event is a transfer from the selected monitored account of the first user to a charitable giving account or a retirement savings account.

10. The method of claim 1 wherein the desired financial event is a credit score falling below a specified threshold or being maintained within a specified range.

11. The method of claim 1 further comprising:
directing, by the server computer, the funds from the source financial account of the second user to a pending rewards account for a period of time prior to transfer to the selected target account of the first user, the funds being defined by the corresponding contribution of the reward criteria when the tracked financial activity information corresponds to the desired financial event;
reducing, by the server computer, at least a portion of the funds in the pending rewards account whenever the desired financial event does not occur during the period of time; and
directing, by the server computer, the reduced funds from the pending rewards account to the selected target account of the first user at the end of the period of time.

12. A computer program product, tangibly embodied in a non-transitory, machine-readable storage device, for establishing an online financial incentive program for fiscally responsible behavior, the computer program product including instructions being operable to cause a data processing apparatus to:
receive first account information from a first user through a first user interface operating on a first client computing device, the first account information identifying one or more financial accounts of the first user authorized by the first user to be monitored by a second user, a level of access set by the first user to control access of the second user to financial activity information of the one or more financial accounts of the first user authorized by the first user to be monitored by the second user, one or more target financial accounts of the first user authorized by the first user to receive funds from the second user;
receive second account information from the second user through a second user interface operating on a second client computing device, the second account information identifying a source financial account of the second user, at least one of the monitored accounts of the first user selected to be monitored, and at least one of the target financial accounts of the first user selected to receive funds from the source financial account of the second user if a reward criteria is met;
receive the reward criteria from the second user through the second user interface, the reward criteria being a desired set of financial events defined by the second user based on the financial activity information accessible to the second user from the selected monitored account of the first user and a corresponding contribution that is applied to the selected target account of the first user from the source financial account of the second user;
track the financial activity information accessible to the second user from the selected monitored account of the first user;
direct funds from the source financial account of the second user to the selected target account of the first user as defined by the corresponding contribution of the reward criteria when the tracked financial activity information corresponds to the desired financial event.

13. A computerized server apparatus for establishing an online financial incentive program for fiscally responsible behavior, comprising:
a processor configured to receive first account information from a first user through a first user interface operating on a first client computing device, the first account information identifying one or more financial accounts of the first user authorized by the first user to be monitored by a second user, a level of access set by the first user to control access of the second user to financial activity information of the one or more financial accounts of the first user authorized by the first user to be monitored by the second user, and one or more target financial accounts of the first user authorized by the first user to receive funds from the second user;
the processor further configured to receive second account information from the second user through a second user interface operating on a second client computing device, the second account information identifying a source financial account of the second user, at least one of the monitored accounts of the first user selected to be monitored, and at least one of the target financial accounts of the first user selected to receive funds from the source financial account of the second user if a reward criteria is met;
the processor further configured to receive the reward criteria from the second user through the second user interface the reward criteria being a desired set of financial events defined by the second user based on the financial activity information accessible to the second user from the selected monitored account of the first user and a corresponding contribution that is applied to the selected target account of the first user from the source financial account of the second user;
the processor further configured to track the financial activity information accessible to the second user from the selected monitored account of the first user;
the processor further configured to direct funds from the source financial account of the second user to the selected target account of the first user as defined by the corresponding contribution of the reward criteria when the tracked financial activity information corresponds to the desired financial event.

14. The computer program product of claim 12 further including instructions being operable to cause the data processing apparatus to:
receive contact information of the second user through the first user interface from the first user; and
use the contact information of the second user to send an electronic invitation to initiate establishment of the second user as one of the third party funding sources of the online financial incentive program.

15. The computer program product of claim 12 further including instructions being operable to cause the data processing apparatus to:
receive contact information of the first user through the second user interface from the second user; and
use the contact information of the first user to send an electronic invitation to initiate establishment of the first user a target participant of the online financial incentive program.

16. The computer program product of claim 12 further including instructions being operable to cause the data processing apparatus to:
direct the funds from the source financial account of the second user to a pending rewards account for a period of time prior to transfer to the selected target account of the first user, the funds being defined by the corresponding contribution of the reward criteria when the tracked financial activity information corresponds to the desired financial event;
reduce at least a portion of the funds in the pending rewards account whenever the desired financial event does not occur during the period of time; and
direct the reduced funds from the pending rewards account to the selected target account of the first user at the end of the period of time.

17. The computerized server apparatus of claim 13 wherein the processor is further configured to:
receive contact information of the second user through the first user interface from the first user; and
use the contact information of the second user to send an electronic invitation to initiate establishment of the second user as one of the third party funding sources of the online financial incentive program.

18. The computerized server apparatus of claim 13 wherein the processor is further configured to:
receive contact information of the first user through the second user interface from the second user; and
use the contact information of the first user to send an electronic invitation to initiate establishment of the first user a target participant of the online financial incentive program.

19. The computerized server apparatus of claim 13 wherein the processor is further configured to:
direct the funds from the source financial account of the second user to a pending rewards account for a period of time prior to transfer to the selected target account of the first user, the funds being defined by the corresponding contribution of the reward criteria when the tracked financial activity information corresponds to the desired financial event;
reduce at least a portion of the funds in the pending rewards account whenever the desired financial event does not occur during the period of time; and
direct the reduced funds from the pending rewards account to the selected target account of the first user at the end of the period of time.

20. The computer-implemented method of claim 1 further comprising:
aggregating, by the server computer, the tracked financial activity information in a first database for a first period of time;
determining, by the server computer, one or more trends in the financial behavior of the first user based on the tracked financial activity information in the first database over the first period of time;
displaying, by the server computer, the one or more trends to the second user through the second user interface; and
receiving, by the server computer, reward criteria from the second user through the second user interface, the reward criteria being a desired set of financial events occurring over a second period of time defined by the second user based on a desired trend in the financial behavior of the first user.

21. The computer program product of claim 12 further including instructions being operable to cause the data processing apparatus to:
aggregate the tracked financial activity information in a first database for a first period of time;
determine one or more trends in the financial behavior of the first user based on the tracked financial activity information in the first database over the first period of time;
display the one or more trends to the second user through the second user interface; and
receive reward criteria from the second user through the second user interface, the reward criteria being a desired set of financial events occurring over a second period of time defined by the second user based on a desired trend in the financial behavior of the first user.

22. The computerized server apparatus of claim 13 wherein the processor is further configured to:
aggregate the tracked financial activity information in a first database for a first period of time;
determine one or more trends in the financial behavior of the first user based on the tracked financial activity information in the first database over the first period of time;
display the one or more trends to the second user through the second user interface; and
receive reward criteria from the second user through the second user interface, the reward criteria being a desired set of financial events occurring over a second period of time defined by the second user based on a desired trend in the financial behavior of the first user.
